(19) United States
(12) Patent Application Publication
(10) Pub. No.: US 2023/0419338 A1
(43) Pub. Date: Dec. 28, 2023

(54) JOINT LEARNING OF TIME-SERIES MODELS LEVERAGING NATURAL LANGUAGE PROCESSING

(71) Applicant: INTERNATIONAL BUSINESS MACHINES CORPORATION, Armonk, NY (US)

(72) Inventors: Shikhar Kwatra, San Jose, CA (US); Shubhi Asthana, Santa Clara, CA (US); PAWAN RAGHUNATH CHOWDHARY, San Jose, CA (US); Indervir Singh Banipal, Austin, TX (US)

(21) Appl. No.: 17/846,359

(22) Filed: Jun. 22, 2022

(51) Int. Cl. G06Q 30/02; G06F 40/30

(52) U.S. Cl. CPC G06Q 30/0201; G06Q 30/0202; G06F 40/30; G06N 20/00

(57) ABSTRACT

Disclosed are methods, computer program products, and systems for maximizing renewals of purchase orders. One embodiment of the method may comprise utilizing a classifier machine learning model to identify metrics that are most relevant to whether customers will renew purchase orders, predicting respective risks of non-renewal for the purchase orders using the identified metrics, applying a tone analyzer natural language processing (NLP) model to determine current sentiments for respective customers, and recommending which of the respective customers to pursue with additional resources based the respectively determined sentiments and risks of non-renewal.

### STATEMENT REGARDING PRIOR DISCLOSURES BY THE INVENTOR OR A JOINT INVENTOR

The following disclosure is submitted under 35 U.S.C. 102(b)(1)(A): S. Asthana, P. Chowdhary, I. Singh Banipal, S. Kwatra and T. Nakamura, “Joint time-series learning framework for maximizing purchase order renewals,” 2021 IEEE International Conference on Big Data (Big Data), Dec. 15, 2021, pp. 4547-4550, doi: 10.1109/BigData52589.2021.9671879.

### BACKGROUND

The present disclosure relates to joint learning of time-series models leveraging natural language processing (NLP), and more specifically, to a system and method for joint learning of time-series models leveraging NLP for maximum purchase order renewals.

Transactions of goods and services between large businesses often utilize a purchase order (PO). The PO, in turn, is a written document that describes the goods and/or services to be delivered, specifies the amounts and prices involved in the transaction, and details the terms under which that delivery will occur. As a result of this detail and its legal significance, POs are often complex documents; for example, a PO might comprise a detailed, hierarchical structure of sub-services, price points over the duration of the PO, base setup cost, billing frequency, renewal terms, etc.

POs for cloud service providers can be especially complex, as cloud services often involve dynamic billing/invoicing for services against the purchase order. In large enterprises with many, high-service-volume cloud service POs, the traditional approach for managing those POs, together with their associated invoices, involved a great deal of inefficiency and labor-intensive manual work. As a result, those organizations often suffered tedious manual monitoring and failed PO renewals, resulting in delays and added costs.

### SUMMARY

One aspect of the disclosure is a method for maximizing renewals of purchase orders. The method may comprise utilizing a classifier machine learning model to identify metrics that are most relevant to whether customers will renew purchase orders, predicting respective risks of non-renewal for the purchase orders using the identified metrics, applying a tone analyzer natural language processing (NLP) model to determine current sentiments for respective customers, and recommending which of the respective customers to pursue with additional resources based the respectively determined sentiment and risks of non-renewal.

One aspect of the disclosure is a computer program product. The computer program product may comprise a computer readable storage medium having program instructions embodied therewith. The program instructions may be executable by a computer to cause the computer to perform a method comprising utilizing a classifier machine learning model to identify metrics that are most relevant to whether customers will renew purchase orders, predicting respective risks of non-renewal for the purchase orders using the identified metrics, applying a tone analyzer natural language processing (NLP) model to determine current sentiments for respective customers, and recommending which of the respective customers to pursue with additional resources based the respectively determined sentiment and risks of non-renewal.

One aspect of the disclosure is a system for maximizing renewals of purchase orders. One embodiment of the system may comprise one or more processors, and a memory communicatively coupled to the one or more processors. The memory may comprise instructions which, when executed by the one or more processors, cause the one or more processors to perform a method comprising utilizing a classifier machine learning model to identify metrics that are most relevant to whether customers will renew purchase orders, predicting respective risks of non-renewal for the purchase orders using the identified metrics, applying a tone analyzer natural language processing (NLP) model to determine current sentiments for respective customers, and recommending which of the respective customers to pursue with additional resources based the respectively determined sentiment and risks of non-renewal.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates one embodiment of a data processing system, consistent with some embodiments.

FIG. 2 illustrates one embodiment of a cloud environment comprising one or more DPS 100, consistent with some embodiments.

FIG. 3 shows a set of functional abstraction layers provided by a cloud computing environment, consistent with some embodiments.

FIG. 4 is a flow chart illustrating a method for managing POs by the PO management system, consistent with some embodiments.

FIG. 5 is a flow chart illustrating one method of managing purchase orders by the PO management system, consistent with some embodiments.

FIG. 6 is a system diagram of a NLP engine for parsing POs in more detail, consistent with some embodiments.

FIG. 7A and 7B collectively are a diagram of a recurrent neural network (RNN), consistent with some embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to joint learning of time-series models leveraging natural language processing (NLP); more particular aspects relate to a system and method for joint learning of time-series models leveraging NLP for maximum purchase order renewals. While the present disclosure is not necessarily limited to such applications, various aspects of the disclosure may be appreciated through a discussion of various examples using this context.

Information Technology (IT) service providers typically use a written Purchase Order (PO) placed with their customers to document the details of the services to be provided during a certain time period for a corresponding payment amount. In strict, PO-driven transactions, billing and invoice payment are typically governed by valid POs with sufficient authorized dollar value remaining. Alternatively or additionally, some IT service engagements may comprise a plurality of payment transactions, in which POs are created but only used as a reference. To manage these relationships, some customers may demand the use of PO management systems. The very complexity of the POs, however, can make digitization technically difficult. This, in turn, can make it technically difficult automate some or all of the associated processes at scale.

Accordingly, one aspect of this disclosure is a system that uses machine learning (ML) and natural language processing (NLP) to proactively initiate the PO renewal process with customers using unstructured conversations (e.g., via text messages). Some embodiments may comprise a joint time-series machine learning ML model that can receive and understand high dimensionality PO data. The ML model may identify one or more metrics that are most relevant to whether or not customers will renew POs. Some embodiments may use an AI intelligent agent to reach out to customers, and then may use time-series prediction coupled with tone analysis to prioritize which customers to target with additional resources in order to increase (e.g., try to maximize) PO renewals.

One aspect of this disclosure is joint learning of time-series models leveraging NLP for a PO management system that can proactively identify likelihood of PO renewal and provide guided service to the workers managing such PO for maximizing engagement.

Some embodiments of this disclosure may provide significant technical advantages. For example, current PO management solutions are limited to building data visualization dashboards for PO flow, with single-trigger alerts and tagging high-value POs. However, many users find that, even if the data is perfectly managed in such systems, it is not straightforward to determine whether any particular PO/PO expiration is going to have issues that will prevent upcoming payment transactions. For example, when the remaining PO amount based on past invoices is low, an IT service provider should determine whether the customer intends to conclude the business relationship when the PO expires, or whether the customer intends to continue the relationship, e.g., so that a new PO can be created before the old one expires. These problems can be compounded because, in a usage-driven charging model discussed above, the upcoming invoice amounts may vary, which makes it more difficult to determine when, exactly, the PO amount will be exhausted. Additionally, the dimensionality of PO data is typically high and extensive, as they typically include many, technically and legally significant details as unstructured information. Hence, the task of extracting important and distinctive features of a PO and customer profile is non-trivial in order to realize an effective technical solution. Accordingly, this disclosure also discusses the results of one embodiment in addressing these issues using a dataset from a global IT service provider.

Another feature and advantage of some embodiments is prioritization based on customer renewal likelihood. In some embodiments, sentiment analysis may be used to identify influences on usage, renewal, etc., as compared to merely identifying trends in usage of services and demand forecasting. Another feature and advantage of some embodiments is that they may reduce the time it takes for customer service representatives (CSRs) to process each PO to identify the POs that require renewal and/or at-risk of exhausting the authorized services in the next few billing cycles.

### Data Processing System (DPS)

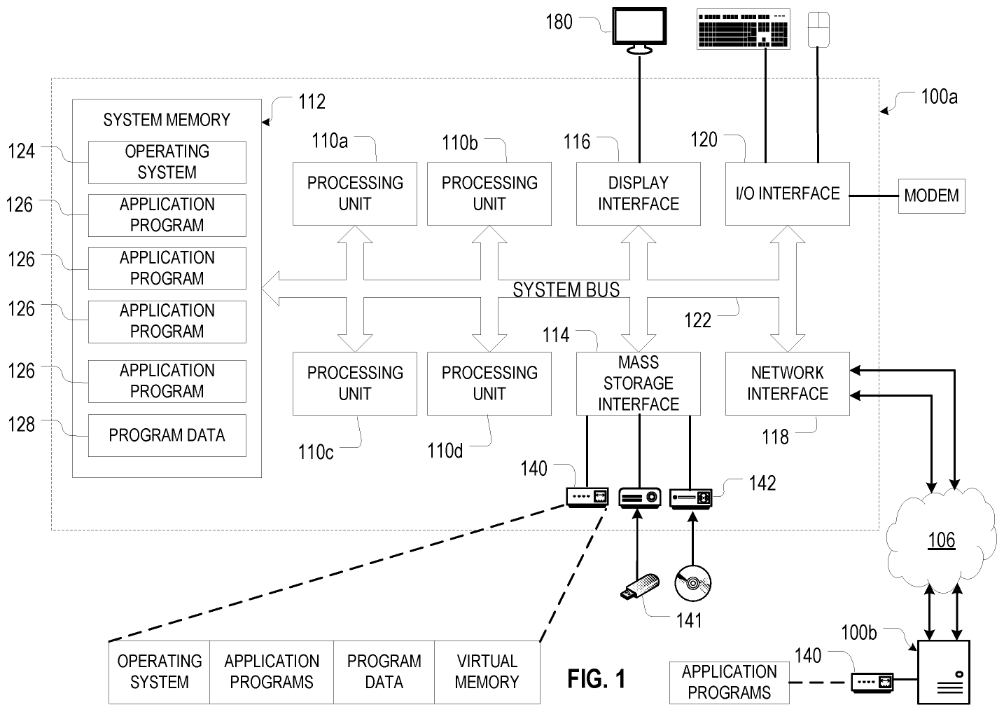

FIG. 1 illustrates one embodiment of a data processing system (DPS) 100a, 100b (herein generically referred to as a DPS 100), consistent with some embodiments. FIG. 1 only depicts the representative major components of the DPS 100, and those individual components may have greater complexity than represented in FIG. 1. In some embodiments, the DPS 100 may be implemented as a personal computer; server computer; portable computer, such as a laptop or notebook computer, PDA (Personal Digital Assistant), tablet computer, or smartphone; processors embedded into larger devices, such as an automobile, airplane, teleconferencing system, appliance; smart devices; or any other appropriate type of electronic device. Moreover, components other than or in addition to those shown in FIG. 1 may be present, and the number, type, and configuration of such components may vary.

The DPS 100 in FIG. 1 may comprise a plurality of processing units 110a-110d (generically, processor 110 or CPU 110) that may be connected to a main memory 112, a mass storage interface 114, a terminal/display interface 116, a network interface 118, and an input/output (“I/O”) interface 120 by a system bus 122. The mass storage interface 114 in this embodiment may connect the system bus 122 to one or more mass storage devices, such as a direct access storage device 140, a USB drive 141, and/or a readable/writable optical disk drive 142. The network interface 118 may allow the DPS 100a to communicate with other DPS 100b over a network 106. The main memory 112 may contain an operating system 124, a plurality of application programs 126, and program data 128.

The DPS 100 embodiment in FIG. 1 may be a general-purpose computing device. In these embodiments, the processors 110 may be any device capable of executing program instructions stored in the main memory 112, and may themselves be constructed from one or more microprocessors and/or integrated circuits. In some embodiments, the DPS 100 may contain multiple processors and/or processing cores, as is typical of larger, more capable computer systems; however, in other embodiments, the DPS 100 may only comprise a single processor system and/or a single processor designed to emulate a multiprocessor system. Further, the processor(s) 110 may be implemented using a number of heterogeneous data processing systems in which a main processor 110 is present with secondary processors on a single chip. As another illustrative example, the processor(s) 110 may be a symmetric multiprocessor system containing multiple processors 110 of the same type.

When the DPS 100 starts up, the associated processor(s) 110 may initially execute program instructions that make up the operating system 124. The operating system 124, in turn, may manage the physical and logical resources of the DPS 100. These resources may include the main memory 112, the mass storage interface 114, the terminal/display interface 116, the network interface 118, and the system bus 122. As with the processor(s) 110, some DPS 100 embodiments may utilize multiple system interfaces 114, 116, 118, 120, and buses 122, which in turn, may each include their own separate, fully programmed microprocessors.

Instructions for the operating system 124 and/or application programs 126 (generically, “program code,” “computer usable program code,” or “computer readable program code”) may be initially located in the mass storage devices, which are in communication with the processor(s) 110 through the system bus 122. The program code in the different embodiments may be embodied on different physical or tangible computer-readable media, such as the memory 112 or the mass storage devices. In the illustrative example in FIG. 1, the instructions may be stored in a functional form of persistent storage on the direct access storage device 140. These instructions may then be loaded into the main memory 112 for execution by the processor(s) 110. However, the program code may also be located in a functional form on the computer-readable media, such as the direct access storage device 140 or the readable/writable optical disk drive 142, that is selectively removable in some embodiments. It may be loaded onto or transferred to the DPS 100 for execution by the processor(s) 110.

With continuing reference to FIG. 1, the system bus 122 may be any device that facilitates communication between and among the processor(s) 110; the main memory 112; and the interface(s) 114, 116, 118, 120. Moreover, although the system bus 122 in this embodiment is a relatively simple, single bus structure that provides a direct communication path among the system bus 122, other bus structures are consistent with the present disclosure, including without limitation, point-to-point links in hierarchical, star or web configurations, multiple hierarchical buses, parallel and redundant paths, etc.

The main memory 112 and the mass storage device(s) 140 may work cooperatively to store the operating system 124, the application programs 126, and the program data 128. In some embodiments, the main memory 112 may be a random-access semiconductor memory device (“RAM”) capable of storing data and program instructions. Although FIG. 1 conceptually depicts the main memory 112 as a single monolithic entity, the main memory 112 in some embodiments may be a more complex arrangement, such as a hierarchy of caches and other memory devices. For example, the main memory 112 may exist in multiple levels of caches, and these caches may be further divided by function, such that one cache holds instructions while another cache holds non-instruction data that is used by the processor(s) 110. The main memory 112 may be further distributed and associated with a different processor(s) 110 or sets of the processor(s) 110, as is known in any of various so-called non-uniform memory access (NUMA) computer architectures. Moreover, some embodiments may utilize virtual addressing mechanisms that allow the DPS 100 to behave as if it has access to a large, single storage entity instead of access to multiple, smaller storage entities (such as the main memory 112 and the mass storage device 140).

Although the operating system 124, the application programs 126, and the program data 128 are illustrated in FIG. 1 as being contained within the main memory 112 of DPS 100a, some or all of them may be physically located on a different computer system (e.g., DPS 100b) and may be accessed remotely, e.g., via the network 106, in some embodiments. Moreover, the operating system 124, the application programs 126, and the program data 128 are not necessarily all completely contained in the same physical DPS 100a at the same time, and may even reside in the physical or virtual memory of other DPS 100b.

The system interfaces 114, 116, 118, 120 in some embodiments may support communication with a variety of storage and I/O devices. The mass storage interface 114 may support the attachment of one or more mass storage devices 140, which may include rotating magnetic disk drive storage devices, solid-state storage devices (SSD) that uses integrated circuit assemblies as memory to store data persistently, typically using flash memory or a combination of the two. Additionally, the mass storage devices 140 may also comprise other devices and assemblies, including arrays of disk drives configured to appear as a single large storage device to a host (commonly called RAID arrays) and/or archival storage media, such as hard disk drives, tape (e.g., mini-DV), writable compact disks (e.g., CD-R and CD-RW), digital versatile disks (e.g., DVD, DVD-R, DVD+R, DVD+RW, DVD-RAM), holography storage systems, blue laser disks, IBM Millipede devices, and the like. The I/O interface 120 may support attachment of one or more I/O devices, such as a keyboard, mouse, modem, or printer (not shown)

The terminal/display interface 116 may be used to directly connect one or more displays 180 to the DPS 100. These displays 180 may be non-intelligent (i.e., dumb) terminals, such as an LED monitor, or may themselves be fully programmable workstations that allow IT administrators and users to communicate with the DPS 100. Note, however, that while the display interface 116 may be provided to support communication with one or more displays 180, the DPS 100 does not necessarily require a display 180 because all needed interaction with users and other processes may occur via the network 106.

The network 106 may be any suitable network or combination of networks and may support any appropriate protocol suitable for communication of data and/or code to/from multiple DPS 100. Accordingly, the network interfaces 118 may be any device that facilitates such communication, regardless of whether the network connection is made using present-day analog and/or digital techniques or via some networking mechanism of the future. Suitable networks 106 include, but are not limited to, networks implemented using one or more of the “InfiniBand” or IEEE (Institute of Electrical and Electronics Engineers) 802.3x “Ethernet” specifications; cellular transmission networks; wireless networks implemented one of the IEEE 802.11x, IEEE 802.16, General Packet Radio Service (“GPRS”), FRS (Family Radio Service), or Bluetooth specifications; Ultra-Wide Band (“UWB”) technology, such as that described in FCC 02-48; or the like. Those skilled in the art will appreciate that many different network and transport protocols may be used to implement the network 106. The Transmission Control Protocol/Internet Protocol (“TCP/IP”) suite contains a suitable network and transport protocols.

### Cloud Computing

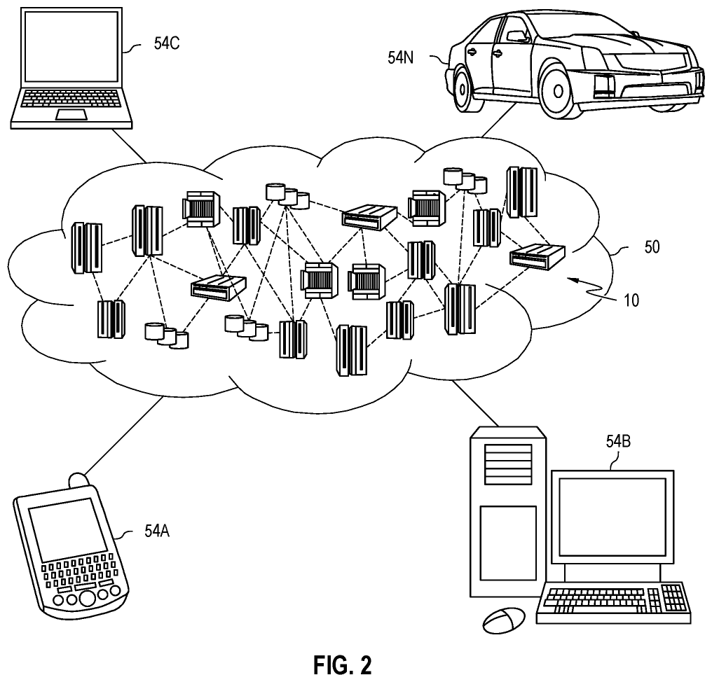

FIG. 2 illustrates one embodiment of a cloud environment comprising one or more DPS 100. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

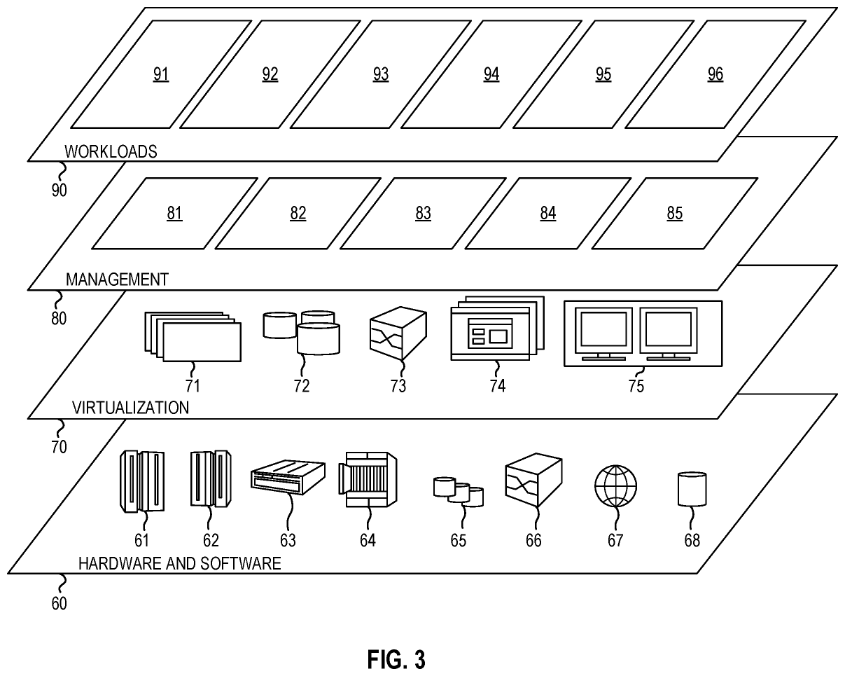

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and PO management system 96.

### PO Management Engine

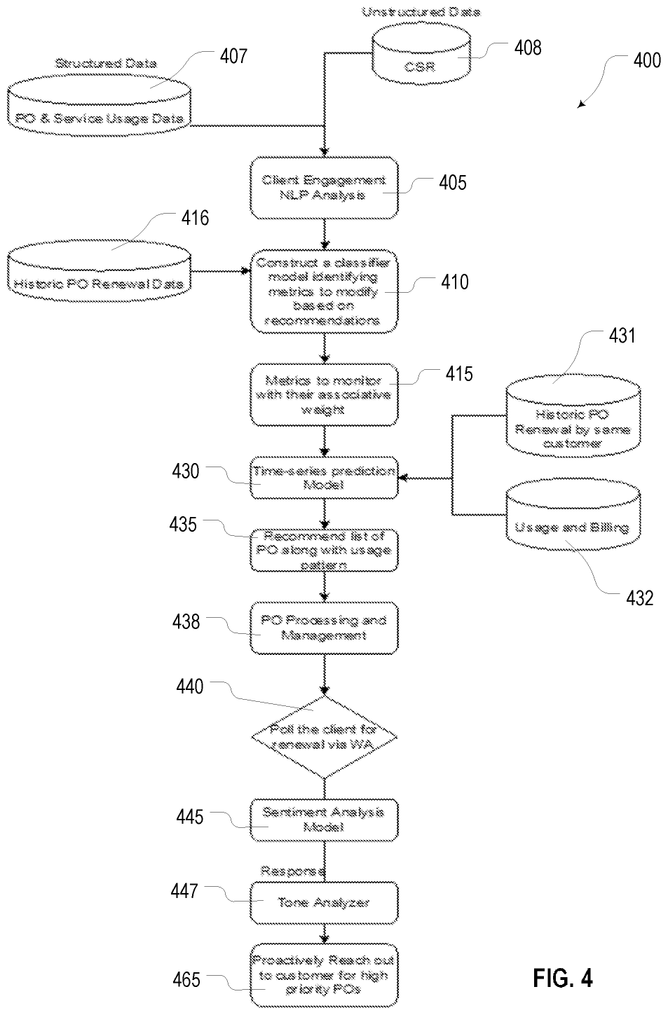

FIG. 4 is a flow chart illustrating a method 400 for managing POs by the PO management system 96, consistent with some embodiments of the present disclosure. Method 400 will be described with reference to an illustrative example comprising a Customer Service Representative (CSR) for an IT services company who wants to know which customers are likely to renew their POs. The CSR in this illustrative example would also like to identify and understand the customers who have under-utilized services under the old PO, thus indicating that they may not be renewing their PO. Lastly, the CSR may want to identify any customers who have over-utilized their authorized PO amount and are nearing the end of the PO term.

In this illustrative example, a joint time-series learning model may be developed in order to identify high-risk POs. The resulting PO management system 96 may implement three operations to identify those POs: 1) evaluating a data set to identify metrics that best indicate whether customers will renew purchase orders; 2) performing time series prediction on each customer's respective usage pattern; and 3) using a tone analyzer natural language processing (NLP) model to determine current sentiments for respective customers with respect to a PO renewal strategy.

The metrics for evaluating each customer PO renewal probability and/or generating the renewal strategy may vary from PO to PO and from service provider to provider. Some POs may be judged based on services utilized, while some may be judged based on the customer's total purchases each year, and still others may be based on PO amount signed. Other factors like market trends, CSR interactions with customer, geography may also play a role in some implementations. The goal of this illustrative example is to identify which POs the CSR should prioritize (i.e., high-risk POs) using, at least in part, customer inclination towards/against renewal of the PO.

In operation, the inputs to the PO management system 96 may include PO text/metadata, service usage/billing data, and historical PO renewal data. Unstructured text data from previous and current conversations between the CSR and the customer may also be ingested. This input data may be analyzed using NLP in a first phase. In a second phase, a usage pattern of the services for each respective customer may be forecast using a time series model. In a third phase, the customer may be engaged, and the resulting communications may be fed to a sentiment analysis model to determine a respective probability of renewal for each customer. The PO management system 96 may output a prioritized list of customers to further engage (e.g., those that may not renew on time).

More specifically, method 400 may begin by evaluating a data set to identify metrics to monitor at operation 405. In this operation, the text of the PO, structured PO metadata and service usage data 407, and unstructured textual data 408 of previous communication between the CSR and the customer may be received. Client engagement natural language processing (NLP) analysis on the collected information may also be performed at operation 405. Creating the customized NLP model may include using a declarative rule language to parse the language of the PO and extract relational information e.g., “who performed what action,” “on whom,” “when,” and “why” from the unstructured input sources. Once the sentences are broken down, a rule based NLP model may be used to understand the purchase order.

In some embodiments, the customized NLP model may be built using the SystemT declarative information extraction system (available from International Business Machines of Armonk, NY. In these embodiments, the customized NLP model may comprise layers of a machine learning model, where the bottom-most is the domain agnostic layer that understands syntactic NLP primitives and operators. This may be followed by a layer for semantic NLP primitives, which may again be domain agnostic. The layers on top may be domain specific layers, which may contain Linguistic Logical Expressions (LLEs) and machine learning models. This layered architecture may help ensure continuous improvement leading to generalization of the target domain, while still making sure the models are not over-fitted to a particular domain/sub-domain.

Next, a machine learning (ML) classifier model may be constructed at operation 410 using the historic PO renewal data 416 and the output of the customized NLP model. The ML classifier model may identify the top features indicative of whether or not the customer will renew the PO using a feature importance function, as well as calculate weights proportional to their associated relevance at operation 415. The metrics/weights may be used as coefficients to a time-series model that can be used with current data to predict a likelihood of PO renewal by each respective customer. In some embodiments, the time-series model may further use the open source PROPHET algorithm (described in more detail in Sean J. Taylor and Benjamin Letham, “Forecasting at scale”, The American Statistician, vol. 72, no. 1, pp. 37-45, 2018). In some embodiments, the list of metrics and the weights may be periodically updated, and the time-series model may be subsequently regenerated, to reflect current influences on actual PO renewals.

The method 400 may then proceed to the second phase: performing the time series prediction on the actual usage patterns of a plurality of current customers using the identified metrics and weights. In this second phase, at operation 430, the generated time-series prediction model may receive historic PO renewal pattern 431, and their current usage and billing information 432, for each of the plurality of customers and recommend a list of POs, at operation 435, that need to be renewed given the current usage pattern. The time-series prediction model in some embodiments may also receive a forecast of likely trend(s) in usage in the next few billing cycles from the CSR in some embodiments (e.g., did the organization recently develop a new feature for their website, at what rate is the economy growing, etc.) Depending on the usage forecast and expiration date of PO, the time-series prediction model may categorize the customer as being at high, medium, or low risk of non-renewal at operation 435.

The method 400 may then begin the third phase, sentiment analysis using NLP. In this third phase, the list may be given to a PO processing and management system (operation 438), which may proactively reach out to each customer to inquire about renewing their POs at operation 440. More specifically, if the future forecast usage pattern is low, the system may use an AI-powered virtual agent (e.g., a chatbot) to integrate the above information and to understand the requirements of the client. If the future forecast usage pattern is high and customer is over-utilizing services, in contrast, the service may integrate the above PO screen of information along with billing and poll the client whether they want to renew the contract on time as well as pay for the overage.

The response(s) from the customer(s) may be fed into a sentiment analysis model 445 at operation 447, which may computationally estimate and/or categorize the customer's current attitude toward PO renewal via tone analysis as generally positive or generally negative. If the output of the sentiment model is generally negative, the PO management system 96 may fetch a ranking/priority associated with the customer at operation 465. For the POs with high priority and generally negative sentiment, the PO management system 96 may recommend that the CSR reach out to the customer at operation 470 and/or expend other resources.

Advantageously, some embodiments may generate a prioritized list of at-risk POs that may be passed to the CSR. Because not all POs can be reviewed manually, and because some organizations may have a high number of POs in high risk categories, some embodiments may also analyze the past PO renewal history of the same customer, and the business risk of that customer leaving, to generate the prioritized list. Some embodiments may evaluate the priority of PO/customer as a function of the risk score, customer history, and the PO's end date. Additionally, the PO management system 96 may continuously capture and reiterate to train the ensemble model in some embodiments. The result of this continuous training process may further refine the probability models, and thus, ensure outreach to the customers who may not otherwise renew a PO on time.

The PO processing and management system may reevaluate the status of the high priority POs regularly in some embodiments. In some embodiments, the PO processing and management system may also analyze the PO and service usage data 407, the past CSR interactions 408, the historic PO renewal information 431, and the current usage and billing information 432 as part of making its prioritized list. In this way, POs that change from low risk to high risk, or from high risk to low risk, may be identified.

### PO Processing and Management System

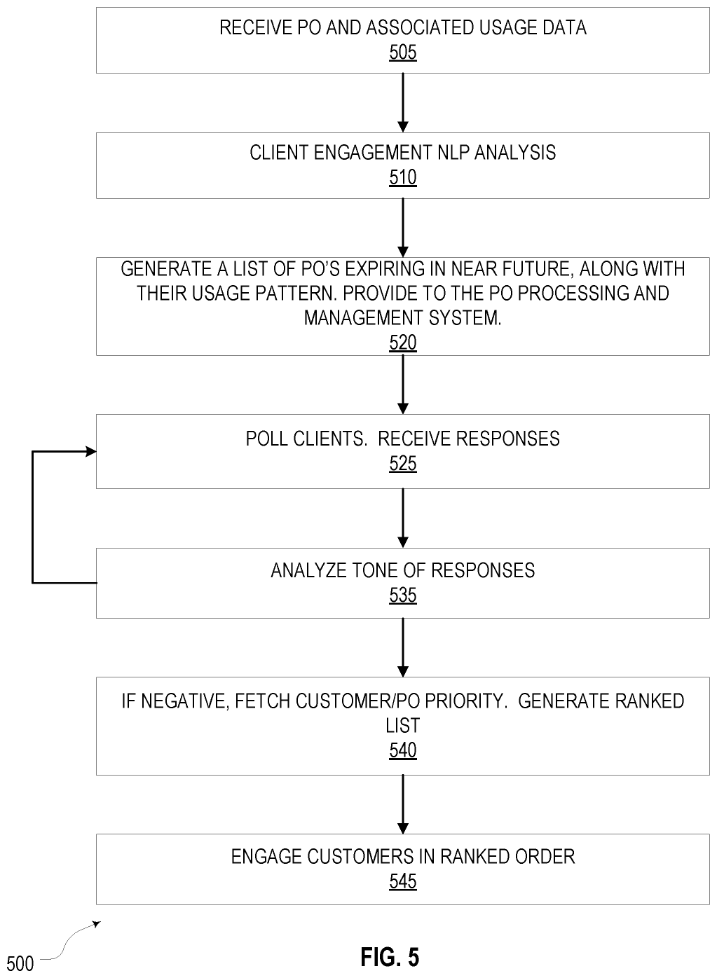

FIG. 5 is a flow chart illustrating one method 500 of managing purchase orders by the PO management system 96, consistent with some embodiments. At operation 505, the PO management system 96 may receive text of a PO and usage data associated with that PO. Some embodiments may also receive structured data containing key performance metrics associated with the POs and unstructured text data comprising communications (e.g., emails, texts, transcribed telephone conversations, etc.) between customer service representatives (CSRs) and the customer. Next, client engagement NLP analysis may be performed on the POs, usage data, structured data, and/or unstructured data at operation 510. This may include feeding the data received at operation 505 into a time-based classifier model to identify metrics to monitor based on recommendations. The time-based prediction model may process the collected metrics, along with the PO renewal history of the same customer, and the billing trend by the same. The time-series model may generate a list of POs expiring in the near future (e.g., 2-3 months), along with their usage pattern. This list may be provided to the main PO processing and management system at operation 520. This operation 520 may be continuously or periodically performed to monitor the POs based on the metrics configured and the weight(s) associated.

For each PO in the generated list, if the PO usage pattern is low, then the PO management system 96 in this embodiment may use an intelligent virtual agent to integrate the above PO screen of information and poll the client at the right time about whether or not the client wants to renew the contract on time. The intelligent virtual agent may be trained on intents, dialogs, and the output of the sentiment analysis model. If the PO usage pattern is high, and customer is over-utilizing services, then the PO management system 96 may use the intelligent virtual agent to integrate the above PO screen of information along with billing and poll the client at operation 525 whether they want to renew the contract on time as well as pay for the overage. The intelligent virtual agent may be trained on intents, dialogs, and the sentiment analysis model.

Based on the client's response, the information received may be fed to an NLP engine infused with a tone analyzer at operation 535. If the overall sentiment model output is positive, the customer may be directed to renew the PO. If the overall sentiment model output is negative, the intelligent virtual agent may fetch (e.g., via a rest API) the client ranking/priority at operation 540. The PO management system 96 may then use the raking to generate a list of customers that should be contacted. If the client is high priority with negative sentiment, then a highly ranked CSR candidate may reach out to the client at operation 545 to, for example, make amends. The PO management system 96 may monitor the above transaction to further compute the delta variation in the sentiment and varied client responses. This event stream of data may optionally be continuously captured and iterated to train the ensemble model.

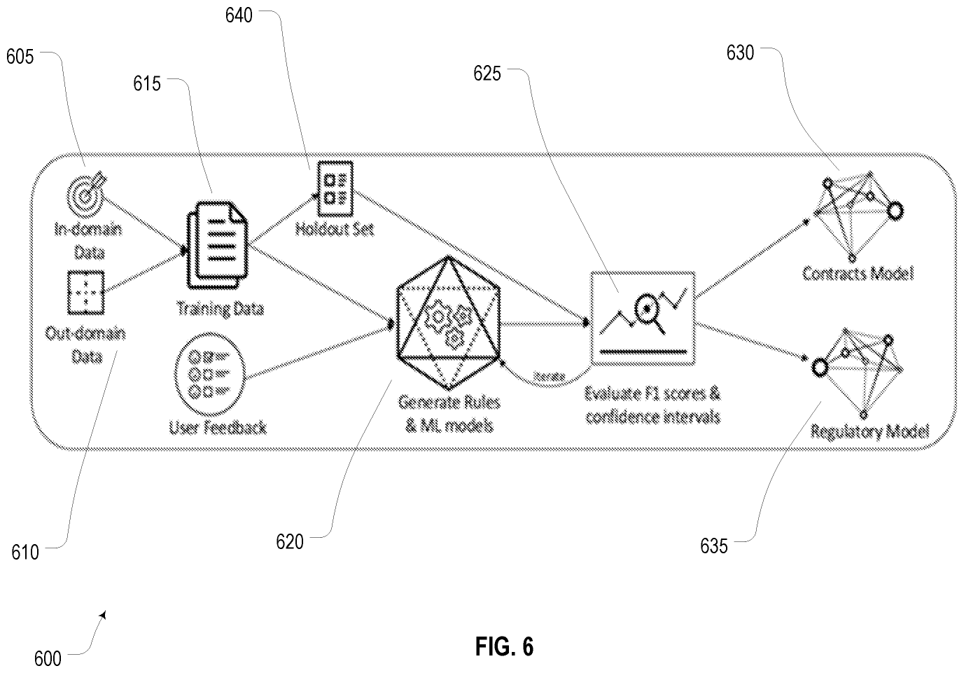

FIG. 6 is a system diagram of a NLP engine 600 for parsing POs in more detail, consistent with some embodiments. In operation, the pipeline 600 may comprise a custom NLP model adapted to parse sentences in the PO into “who performed what action on whom and when, why.” To create the custom NLP model, in-domain data 605 and out-domain data (e.g., technical documentation, other legal documents, etc.) 610 may be combined into a training dataset 615. The in-domain data 605 may comprise one or more of:
1. PO followed by the user over the given time interval.
2. Conditions of the PO signed off by the user for that time interval.
3. Actual usage of the services by the user (separately extracted from the usage reports generated by the system).
4. Resources under-utilized by the user.
5. Resources over-utilized by the user.
   Categories 4 and 5 of the in-domain data 605 may be calculated in some embodiments by comparing the usage reports and the actual contracts/POs. The compliance component may be calculated by comparing the model output and the actual usage over time.

The training data set 615 may be fed into the ML model and used to generate prediction rules 620. These prediction rules may be compared to actual PO renewal results, e.g., by calculating F1 scores and confidence intervals 625. If the error is greater than a threshold, the weights in the ML model may be updated and new prediction rules may be generated. If the error is below a threshold, then a holdout data set 640 may be used to validate the prediction rules. The output of the ML model may be a contracts model 630, a regulatory document model 635, etc., depending on how the model is trained.

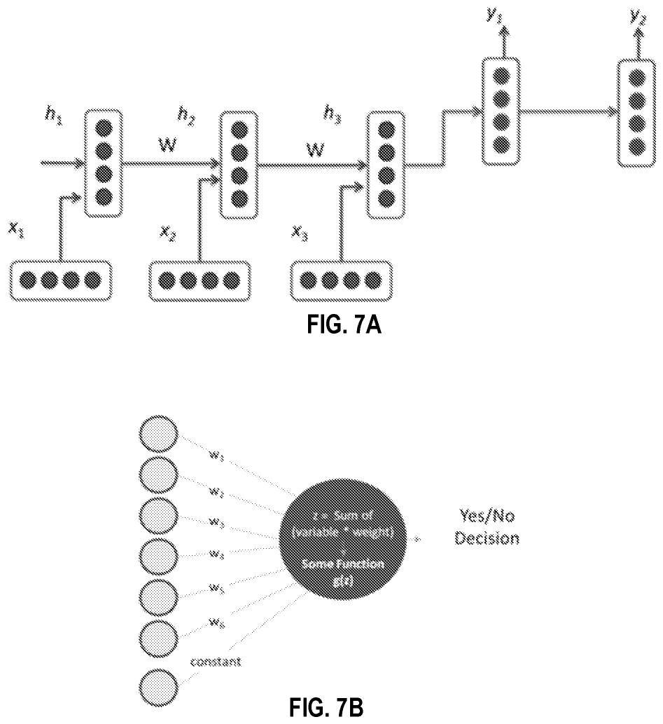

The ML model in some embodiments may comprise a recurrent neural network (RNN). FIG. 7A and 7B collectively are a diagram of one RNN 700, consistent with some embodiments. In FIG. 7, the inputs may correspond to a difference of the compare and compliance found over time. The outputs y₁, y₂ . . . yₙ may correspond to a list of the recommended actions over the time based on the usage and their compliance with the contracts/POs over the time. The output of the RNN 700 may be used to decide whether or not to invoke the AI-powered virtual agent. In one embodiment, this may depend on the [y1, y2 . . . yn] generated by the RNN 700 above:

z=Σ(yₙ*wₙ)=some function G(z)
where Z is the decision Yes/No, which represents whether or not a chatbot instantiation should occur; Wn represents the weights of the model that get trained over time with more and more training examples; and Yn represents the output of time series model RNN.

### Results

The method and systems described with reference to FIGS. 1-7 was applied to manage active ongoing POs, leveraging forecasts from the time series data and the sentiment analysis model. The effectiveness of this tool was shown using real-world PO and invoice data from one of the world's biggest information technology service providers. In particular, this tool was shown for users in US geography to provide more indicative forecasting of usage of services using a selected a set of 4,500 POs and more than a million records from the aforementioned repository.

In operation, the trained classifier model identified the top metrics to monitor in the PO: (i) total amount; (ii) usage; (iii) PO start and end date; (iv) renewal lead time; and (v) billing frequency. This embodiment fetched the unstructured comments on communication between customer and CSR and performed NLP analysis. The database included 1,200 comments for analysis across these POs. After building the NLP stack, the models were built to structure the comments and fed to the classifier model. The classifier model ranked the top features influencing the PO renewals. The accuracy of the classifier model built on these comments was 0.25.

The time series prediction was built on usage pattern using the PROPHET forecasting model described above. This embodiment used the open source PROPHET algorithm to analyze the trend of usage of services in the past, and forecast them in the next few billing cycles. This embodiment also cross-validated the forecast with actual usages. FIG. 5 shows a sample comparison of actual versus predicted forecast in future billing cycles for a certain PO. The trained PROPHET algorithm used by this embodiment provided a high accuracy of 0.8 when trained on a set of 4,500 POs.

Using the forecast usage, this embodiment calculated the risk of PO exhausting its amount. Along with the customer renewal history, the priority of PO was calculated using the function below:

PO_score=PO_risk+Σ(PO_amt−PO_amtremaining)number_of_future_billing_cycles
The calculated PO_score gave the priority of PO and was used by PO management tool while filtering high priority ones. For the example training set of 4000 POs, the mean accuracy of PO_score was found to be 0.3.

Additionally, this embodiment performed linguistic analysis on the high priority POs to detect emotional and language tones in transcribed text. This was used to escalate customer conversations when they turned negative or when opportunities were found to improve customer service scripts, dialog strategies, and customer journeys. This embodiments extracted the features from client transcripts using the supported API service and formulated machine learning methodology to classify the language tone (analytical, confident and tentative) and emotional tone (anger, fear, joy and sadness), as described in more detail in K. Ralston, Y. Chen, H. Isah and F. Zulkernine, “A Voice Interactive Multilingual Student Support System using IBM Watson”, 2019 18th IEEE International Conference On Machine Learning And Applications (ICMLA), pp. 1924-1929, 2019. However, for classification, other embodiments may create and use different classifiers, including Naive Bayes, random forest, and sequential minimal optimization.

In the deployment of the tool discussed above, the priority of POs and structured comments was found useful by the organization. The linguistic analysis helped initiate proactive actions to reaching out to customers who had more than 60% chance of not renewing. In this way, large number of POs facing expiration were successfully renewed on time, thus improving the cash flow.

### Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a subsystem, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### General The descriptions of the various embodiments of the present disclosure have been

presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

Therefore, it is desired that the embodiments described herein be considered in all respects as illustrative, not restrictive, and that reference be made to the appended claims for determining the scope of the invention.

What is claimed is:

1. A method for maximizing renewals of purchase orders, comprising:
utilizing a classifier machine learning model to identify metrics that are most relevant to whether customers will renew purchase orders;
predicting respective risks of non-renewal for the purchase orders using the identified metrics;
applying a tone analyzer natural language processing (NLP) model to determine current sentiments for respective customers; and
recommending which of the respective customers to pursue with additional resources based the respectively determined sentiments and risks of non-renewal.

2. The method of claim 1, wherein the predicting the respective risks of non-renewal for purchase orders is further based on historical data for customers associated with the purchase orders.

3. The method of claim 1, further comprising engaging each of a plurality of customers using a virtual assistant about purchase order renewal; and receiving corresponding customer responses.

4. The method of claim 1, further comprising building the classifier machine learning model, wherein the building comprises:
analyzing invoice usage data and past renewal history for the customer; and
predicting an amount of time remaining on the purchase order.

5. The method of claim 1, wherein recommending which of the respective customers to pursue comprises:
analyzing a PO usage pattern and the current sentiment for each of the respective customers; and
generating a ranked list of customers to pursue using the PO usage pattern and the current sentiment.

6. The method of claim 1, further comprising extracting, by a customized natural language model, relationship information from the purchase orders.

7. The method of claim 6, wherein the purchase order identifies cloud services to be provided to a particular customer during a certain time period for a corresponding payment amount.

8. A computer program product, comprising a computer readable storage medium having program instructions embodied therewith, the program instructions being executable by a computer to cause the computer to perform a method comprising:
utilizing a classifier machine learning model to identify metrics that are most relevant to whether customers will renew purchase orders;
predicting respective risks of non-renewal for the purchase orders using the identified metrics;
applying a tone analyzer natural language processing (NLP) model to determine current sentiments for respective customers; and
recommending which of the respective customers to pursue with additional resources based the respectively determined sentiments and risks of non-renewal.

9. The computer program product of claim 8, wherein the predicting the respective risks of non-renewal for purchase orders is further based on historical data for customers associated with the purchase orders.

10. The computer program product of claim 8, wherein the method further comprises:
engaging each of a plurality of customers using a virtual assistant about purchase order renewal; and
receiving corresponding customer responses.

11. The computer program product of claim 8, wherein the method further comprises building the classifier machine learning model, wherein the building comprises:
analyzing invoice usage data and past renewal history for the customer; and
predicting an amount of time remaining on the purchase order.

12. The computer program product of claim 8, wherein recommending which of the respective customers to pursue comprises:
analyzing a PO usage pattern and the current sentiment for each of the respective customers; and
generating a ranked list of customers to pursue using the PO usage pattern and the current sentiment.

13. The computer program product of claim 8, wherein the method further comprises extracting, by a customized natural language model, relationship information from the purchase orders.

14. The computer program product of claim 13, wherein the purchase order identifies cloud services to be provided to a particular customer during a certain time period for a corresponding payment amount.

15. A system for maximizing renewals of purchase orders, the system comprising:
one or more processors; and
a memory communicatively coupled to the one or more processors;
wherein the memory comprises instructions which, when executed by the one or more processors, cause the one or more processors to perform a method comprising:
utilizing a classifier machine learning model to identify metrics that are most relevant to whether customers will renew purchase orders;
predicting respective risks of non-renewal for the purchase orders using the identified metrics;
applying a tone analyzer natural language processing (NLP) model to determine current sentiments for respective customers; and
recommending which of the respective customers to pursue with additional resources based the respectively determined sentiments and risks of non-renewal.

16. The system of claim 15, wherein the predicting the respective risks of non-renewal for purchase orders is further based on historical data for customers associated with the purchase orders.

17. The system of claim 15, wherein the method further comprises:
engaging each of a plurality of customers using a virtual assistant about purchase order renewal; and
receiving corresponding customer responses.

18. The system of claim 15, wherein the method further comprises building the classifier machine learning model, wherein the building comprises:
analyzing invoice usage data and past renewal history for the customer; and
predicting an amount of time remaining on the purchase order.

19. The system of claim 15, wherein recommending which of the respective customers to pursue comprises:
analyzing a PO usage pattern and the current sentiment for each of the respective customers; and
generating a ranked list of customers to pursue using the PO usage pattern and the current sentiment.

20. The system of claim 15, wherein the method further comprises extracting, by a customized natural language model, relationship information from the purchase orders.
